(19) United States
(12) Patent Application Publication
(10) Pub. No.: US 2022/0319476 A1
(43) Pub. Date: Oct. 6, 2022

(54) PORTABLE TOOL FOR DRAWING A MUSIC STAFF

(71) Applicant: Francesco Boschetto, Nono (AR)

(72) Inventor: Francesco Boschetto, Nono (AR)

(21) Appl. No.: 17/223,155

(22) Filed: Apr. 6, 2021

(51) Int. Cl. G10G 3/02; B21D 53/82

(52) U.S. Cl. CPC G10G 3/02; B21D 53/82

(57) ABSTRACT

A portable article of stationery for drawing a variety of music staves by hand.

It consists of a thin plate of rigid material (ex. stainless steel) on which a number of parallel through-grooves are cut horizontally.

By inserting the tip of a pen, or pencil, through each of said grooves, one can easily draw a number of parallel lines forming a music staff.

### BACKGROUND

### Field of Invention

This invention relates to music writing and notation in general and composing, arranging or music studying in particular.

### Discussion of Prior Art

Prior tools designed to draw a music staff include
a) a five-pointed boligraph (commercial names: QuikStaff and Noligraph) and
b) a plastic ruler with a sliding guide with 5 holes in it to insert a pen and draw parallel lines (commercial name: Lineslider by Momiji).

These inventions solved the problem only partially, as in the case of QuikStaff and Noligraph, where:
1- any of the 5 boligraphs can fail or dry up making the tool not fit for drawing at any time;
2- the color and type of ink are limited to those of the included boligraphs;
3- the life of the article is only as long as any of its writing tips, making it not the preferable choice in terms of durability and ecology of materials;

and in the case of Lineslider, where:
1- the complex construction and its delicate materials combined with a typically casual use, result in a certain degree of fragility, which can cause the mechanism to perform poorly, jam or break;
2- the length of the staff drawn using this ruler reaches a maximum of 16 cm, while a full length staff across a page measures about 19 cm.

### Objects and Advantages

Accordingly, here are several objects and advantages of my invention:

Durability: produced with materials such as stainless steel, hard wood, or very hard plastic and designed as one piece with no frail mechanisms or easily perishable parts, this invention is made to last for a lifetime and beyond.

Cost/Technical Advance: produced with a relatively new and competitive technique (called etching) to cut metals (in the case of the main, stainless steel embodiment), this article can be marketed at significantly lower prices than the prior equivalents.

Reliability: this music staff ruler is so essential and stable in its conception that, with a pen or pencil at hand, it cannot fail to provide the composer or music student with the ability to draw a music staff and write down a music idea at any time.

Flexibility: without any short-lived writing devices, such as boligraphs, the user is able to choose everytime the kind of pen, ink color, or pencil she or he might prefer at the moment.

Size: this invention comes in different sizes: a shorter version, to prioritize transportability, and a longer version, to prioritize the drawing of full-length music staves.

Appearance: the simplicity of this music ruler's design and the quality of the materials employed in its construction result in a timeless aesthetic that is meant to appeal to the artistic spirit of its users.

Further objects and advantages of my invention will become apparent from a consideration of the drawings and ensuing description.

### DESCRIPTION OF INVENTION

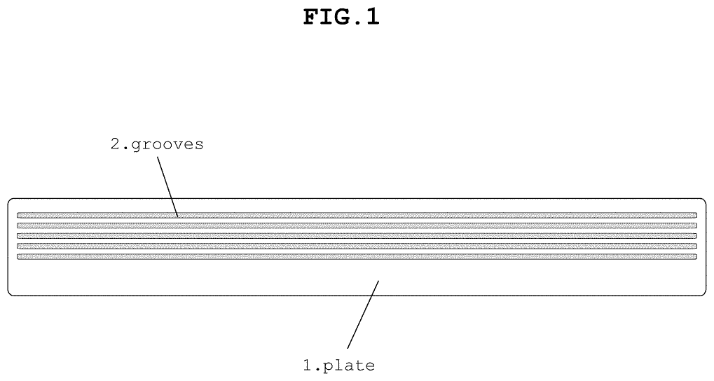

As illustrated in FIG. 1 (top view), the present invention is constituted by a thin plate (1) made of a hard material (stainless steel, hard wood, hard plastic, etc.), and a number (up to 5) of parallel grooves (2), cut all the way through the plate.

### OPERATION

The manner of using the present invention is very similar to the way a common stationary ruler is used to draw a straight line. Namely, one first holds down the plate by pressing the left-hand fingers (in the case that the user is right-handed) on the plate's lower area. Next, one inserts the tip of a pen or pencil into one of the grooves and, guided by said groove, traces a line from start to end (or from any desired point to another). Then one proceeds to draw the rest of the lines in a similar way, one by one, using the rest of the grooves as guides, thus obtaining a group of parallel lines.

### CONCLUSION, RAMIFICATIONS, AND SCOPE

The reader can see how easy and practical it is to draw a music staff with the aid of this ruler. The reader surely can also appreciate how this invention is stripped of all elements that can significantly limit its durability and restrict the possibilities of its use.

In other embodiments the number of lines constituting the music staff may vary according to the type of staff one may need to draw (for example, guitar tablature diagrams are made of 6 lines). The shape of the plate could be other than a rectangle. The color may be any one chosen by the designer or customer.

Dimensions, especially length, may vary to produce a shorter, more portable, ‘pocket’ version of the invention, or, conversely, a longer, ‘desk’ version of it to draw full-size staves.
Materials may be stainless steel (preferred embodiment), but also other metals or hard wood, or any very hard plastic or other synthetic material.
In the case of a hard wood embodiment, the manufacturing process may differ as it might be necessary to produce different parts separately.

I claim:

1. An article of stationery for drawing a variety of music staves by hand, comprising:
(a) a plate of rigid material of predetermined size,
(b) a number of longitudinal and parallel grooves cut through said plate and running across most of the length of said plate with a predetermined distance from one another, whereby a person can easily draw, by inserting a common pen or pencil into said grooves and using them as guides, a number of parallel lines constituting a music staff.

2. The article of claim 1 wherein said plate of rigid material is made of stainless steel.

3. The article of claim 1 wherein said grooves are cut at a distance of 0.4 mm of one another.

4. The article of claim 1 wherein said grooves are each 0.4 mm in height.

5. The article of claim 1 wherein the length of each groove is of 19 cm.

6. The article of claim 1 wherein the length of each groove is of 15 cm.

7. The article of claim 1 wherein said plate of rigid material is composed of hard wood.

8. The article of claim 1 wherein said plate of rigid material is composed of hard plastic or other hard synthetic material.

9. The article of claim 1 wherein said plate of rigid material has a thickness of 0.7 mm

10. The article of claim 1 wherein said plate of rigid material has a thickness of 0.5 mm.
